(19) United States
(12) Patent Application Publication
(10) Pub. No.: US 2004/0023541 A1
(43) Pub. Date: Feb. 5, 2004

(54) IC card connector

(76) Inventor: Ming-Te Wang, Hsintien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/208,803

(22) Filed: Aug. 1, 2002

(51) Int. Cl. H01R 13/15

(52) U.S. Cl. 439/260

(57) ABSTRACT

An IC card connector includes a insulation housing holding two symmetrical rows of terminals at front and rear sides, the terminals each having a contact portion suspended inside the insulation housing, and an actuating member pivoted to the inside of the insulation housing and adapted for pressing the contact portions of the terminals on respective contacts of the IC chip of an IC card upon insertion of the IC card into the insulation housing and for enabling the contact portions of the terminals to be returned to their former position by spring power of the terminals upon removal of the inserted IC card from the insulation housing.

### BACKGROUND OF THE INVENTION

1. Field of the Invention

The present invention relates to an IC card connector adapted for connecting an IC card to a circuit board and, more particularly, to a simple structure of IC card connector, which enables the IC card to be smoothly loaded/unloaded with less effort.

2. Description of the Prior Art

FIGS. 1 and 2 show an IC card connector 10a connectable to a circuit board and adapted for receiving an IC card 30a, for example a smart card or SIM (subscriber identity module) card, for enabling the received IC card to be electrically connected to the circuit board in which the IC card connector 10a is installed. The IC card connector 10a comprises an insulation housing 11a, a plurality of terminals 12a, and a slide 13a. The terminals 12a are arranged into two rows, each row including a plurality of (for example 4) terminals. Each terminal 12a has a soldering portion 14a extended out of the housing 11a for soldering to an external circuit board, and a contact portion 15a suspended inside the insulation housing 11a. Further, the insulation housing 11a comprises two sliding rails 16a. The slide 13a is slidably mounted on the sliding rails 16a having holes 17a corresponding to the contact portions 15a of the terminals 12a.

As illustrated in FIG. 3, when an IC card 30a inserted into the insulation housing 11a, the slide 13a is moved with the inserted IC card 30a forwards. At this time, a guide face 22a of the slide 13a guides the contact portions 15a of the terminals 12a upwards through the holes 17a into contact with respective contacts of the IC chip 31a of the IC card 30a.

Further, a spring member 18a is mounted inside the housing 11a. The spring member 18a is a torsional spring, having one end stopped at the front side of the slide 13a and an opposite end stopped at one lateral sidewall of the insulation housing 11a. The spring member 18a is adapted to return the slide 13a to its former position after each movement. A retaining mechanism 19a is provided for securing the slide 13a in position after the slide 13a has been moved to the front side. The retaining mechanism 19a comprises a springy retainer 20a protruded from the slide 13a, and a retaining hole 21a disposed in the front side of one sliding rail 16a.

When the slide 13a moved forwards with the inserted IC card 30a into position (see FIG. 3), the springy retainer 20a is forced into engagement with the retaining hole 21a to secure the slide 13a in position. When the IC card 30a is pulled backwards from the insulation housing 11a, the springy retainer 20a is released from the constraint and disengaged from the retaining hole 21a, for enabling the slide 13a to be pushed backwards to its former position by the spring power of the spring member 18a, and at the same time, the contact portions 15a of the terminals 12a are received inside the holes 17a due to the effect of the material spring power of the terminals 12a. Therefore, the contact portions 15a of the terminals 12a are prohibited from rubbing the IC chip 31a of the IC card 30a when pulling the IC card 30a out of the insulation housing 11a.

This structure of IC card connector is functional, however the user needs to employ much effort to insert the IC-card into the IC card connector or to pull the IC card out of the IC card connector. Further, this structure of IC card connector is complicated, resulting in high manufacturing cost.

### SUMMARY OF THE INVENTION

The present invention has been accomplished to provide an IC card connector, which eliminates the aforesaid drawbacks. It is one object of the present invention to provide an IC card connector, which enables the IC card to be smoothly loaded/unloaded with less effort. It is another object of the present invention to provide an IC card connector, which ensures positive contact between the terminals of the IC card connector and the respective contact of the IC chip of the IC card. It is still another object of the present invention to provide an IC card connector, which is inexpensive to manufacture. To achieve these and other objects of the present invention, the IC card connector comprises an electrically insulative housing adapted for receiving an IC card having an IC chip; a plurality of terminals mounted inside the housing for contact with respective contacts of the IC chip of an IC card inserted into the housing, the terminals each having one end terminating in a contact portion suspended inside the housing for contacting a respective contact of the IC card inserted into the housing; and an actuating member pivoted to the inside of the housing, the actuating member having a bearing portion, and-a push portion supporting the contact portions of the terminals. When inserting an IC card into the housing, the inserted IC card forces the bearing portion of the actuating member downwards, thereby causing the push portion of the actuating member to be moved upwards to press the contact portions of the terminals on respective contacts of the IC chip of the inserted IC card.

### BRIEF DESCRIPTION OF THE DRAWINGS

FIG. 1 is a top view of an IC card connector according to the prior art.

FIG. 2 is a sectional side view of the IC card connector according to the prior art.

FIG. 3 is an applied view of the prior art design, showing an IC card inserted into the IC card connector.

FIG. 4 is an elevational view of an IC card connector according to the present invention.

FIG. 5 is an exploded view of the IC card connector according to the present invention.

FIG. 6 is a sectional side view of the IC card connector according to the present invention.

FIG. 7 is an applied view of the present invention showing an IC card inserted into the IC card connector.

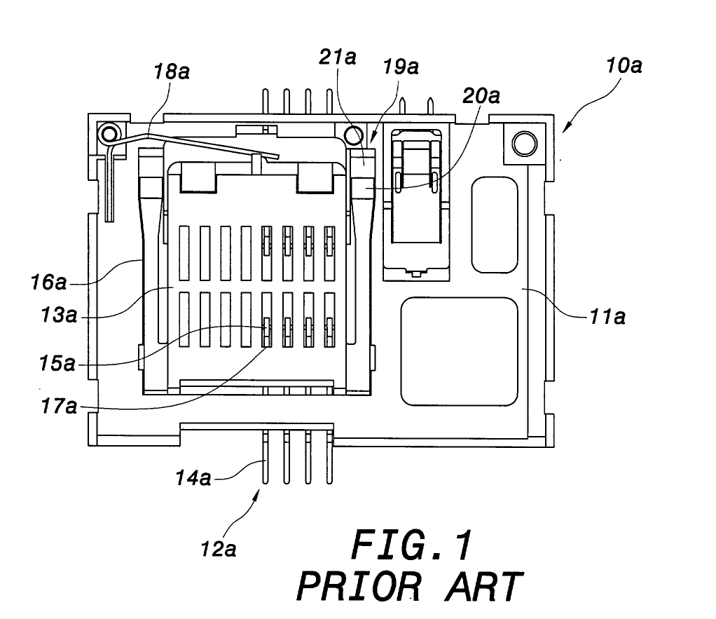

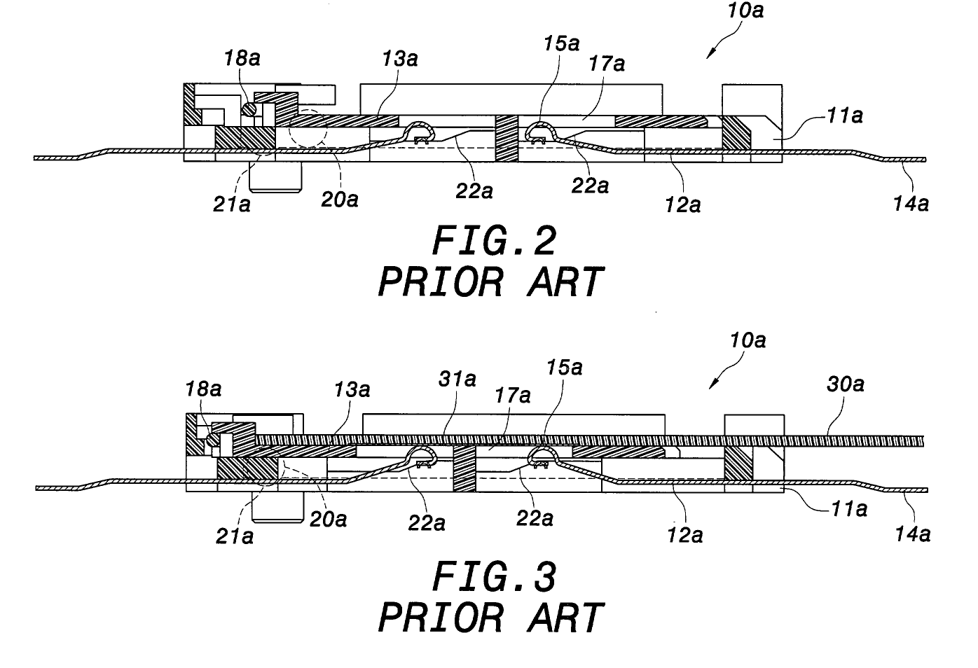

### DETAILED DESCRIPTION. OF THE PREFERRED EMBODIMENT

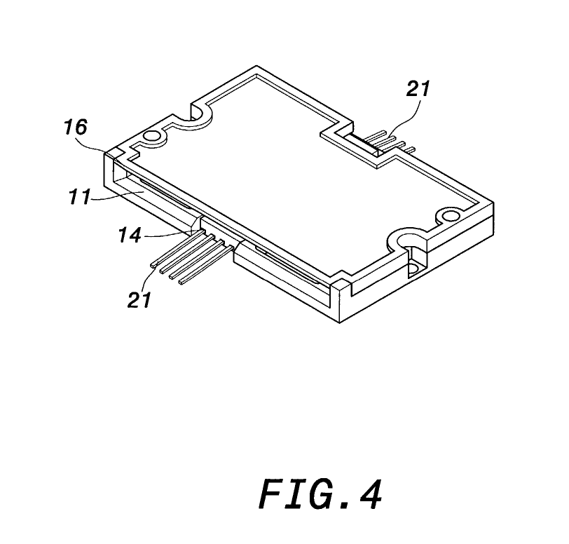

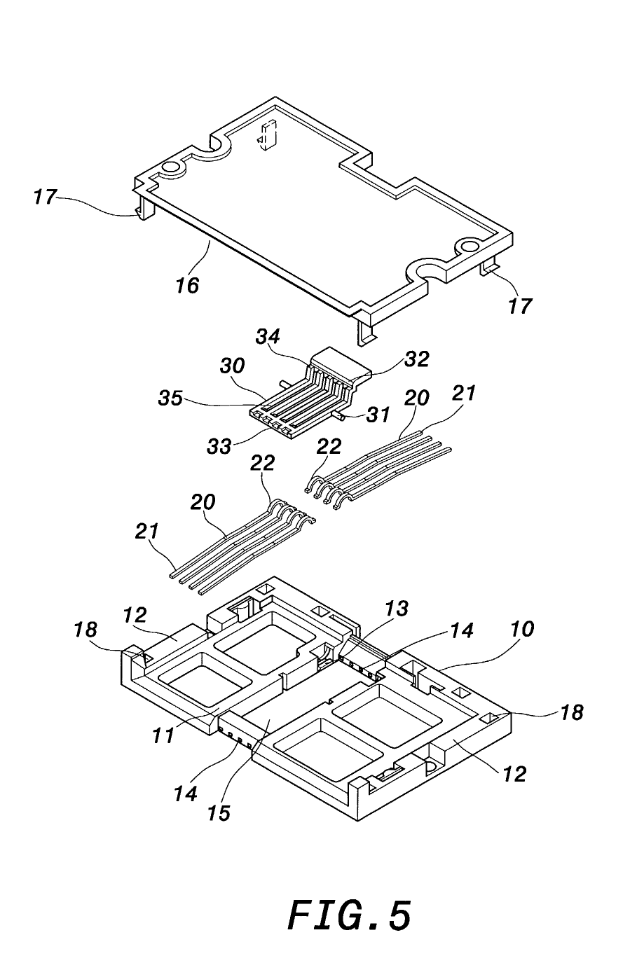

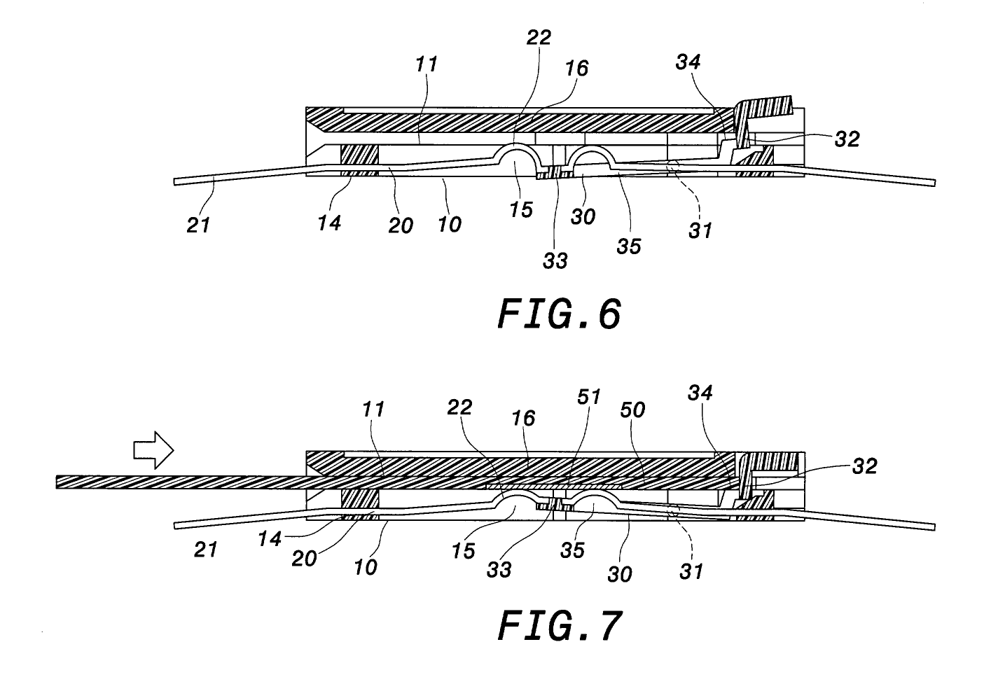

Referring to FIGS. 4˜6, an IC card connector in accordance with the present invention is generally comprised of an electrically insulation housing shaped like a flat box and formed of a bottom cover shell 10 and a top cover shell 16, a plurality of terminals 20, and an actuating member 30.

The bottom cover shell 10 and the top cover shell 16 are injection-molded from plastics. The top cover shell 16 is covered on the bottom cover shell 10, defining with the bottom cover shell 10 an insertion slot 11 for receiving an IC card, for example a smart card or SIM (subscriber identity module) card. The bottom cover shell 10 comprises two side walls 12 disposed at two sides of the insertion slot 11 and adapted for guiding an IC card into the inside of the insertion slot 11, a center opening 15, two rows of terminal holes 14 arranged in front and rear sides inside the insertion slot 11 on the middle and spaced by the center opening 15, two pivot holes 13 disposed at two opposite lateral sides of the center opening 15, and a plurality of hook holes 18 symmetrically disposed in the side walls 12. The top cover shell 16 is covered on the bottom cover shell 10 to hold the terminals 20 and the actuating member 30 inside the bottom cover shell 10, having a plurality of hooks 17 respectively hooked in the hook holes 18 of the bottom cover shell 10.

The terminals 20 are made of electrically conducting resilient material and respectively mounted in the terminal holes 14 of the bottom cover shell 10, each having one end terminating in a soldering portion 21 and the other end terminating in an arched contact portion 22. The soldering portions 21 of the terminals 20 extend out of the front or rear side of the bottom cover shell 10. The contact portions 22 of the terminals 20 are respectively suspended in the center opening 15.

The actuating member 30 is mounted inside the bottom cover shell 10 corresponding to the center opening 15, comprising two pivot rods 31 symmetrically disposed at two opposite lateral sides thereof and respectively pivoted to the pivot holes 13 of the bottom cover shell 10 for enabling the actuating member 30 to be alternatively moved up and down on the axis passing through the pivot holes 13 and the pivot rods 31, a bearing portion 32 disposed at one end, a push portion 33 disposed at the other end, a guide portion 34 extended in direction from the bearing portion 32 toward the push portion 33, and a plurality of terminal slots 35 longitudinally extended between the guide portion 34 and the push portion 33.

The contact portions 22 of the terminals 21 inserted in the terminal holes 14 at the front side of the center opening 15 are respectively supported on the push portion 33 of the actuating member 30. The contact portions 22 of the terminals 20 inserted in the terminal holes 14 at the rear side of the center opening 15 are respectively inserted through the terminal slots 35 of the actuating member 30 from the bottom side toward the top side and then supported on the push portion 33 of the actuating member 30.

Referring to FIG. 7, when inserting an IC card 50 into the insertion slot 11, the front side of the IC card 50 will touch the guide portion 34 of the actuating member 30 at first, and then be guided by the guide portion 34 to the bearing portion 32. When touched the bearing portion 32, the front side of the IC card 50 forces the bearing portion 32 downwards, thereby causing the push portion 33 to be moved upwards to force the contact portions 22 of the terminals 20 into close contact with respective contacts (not shown) of the IC chip 51 of the IC card 50, and therefore the IC card 50 is positively secured to the inside of the IC card connector and electrically connected to the terminals 20.

When pulling the IC card 50 backwards to disengage the front side of the IC card 50 from the bearing portion 32 of the actuating member 30, the spring power of the terminals 20 immediately returns the actuating member 30 to its former position, i.e., the push portion 33 of the actuating member 30 is moved downwards and, the portion 32 of the actuating member 30 is moved upwards, thereby causing the contact portions 22 of the terminals 20 to be returned to their former position away from the IC chip 51 of the IC card. 50, for enabling the. IC card 50 to be smoothly taken out of the IC card connector.

As indicated above, the IC card connector enables the user to load/unload the IC: card smoothly with less effort. When the IC card 50 inserted into the IC card connector, the actuating member 30 is moved to press the contact portions 22 of the terminals 20 on the respective contacts of the IC chip 51 of the IC card 50, ensuring positive contact between the IC card 50 and the IC card connector. Because the spring power of the terminals 20 is used to return the actuating member 30, no additional return spring means is necessary, and therefore the manufacturing cost of the IC card connector is greatly reduced.

A prototype of IC card connector has been constructed with the features of the annexed drawings of FIGS. 4˜7. The IC card connector functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An IC card connector comprising:
an insulation housing adapted for receiving an IC card having an IC chip;
a plurality of terminals respectively having a contact portion formed in one end thereof for said contact portion contacting with the IC chip of the IC card, said terminals being mounted inside said insulation housing; and
an actuating member pivoted to the inside of said housing, said actuating member having a bearing portion, and a push portion supporting said contact portions of said terminals;
whereby inserting an IC card into said insulation housing, said inserted IC card forces said bearing portion of said actuating member downwards so that causing the push portion of said actuating member to be moved upwards to press the contact portions of said terminals on respective contacts of the IC chip of the IC card.

2. The IC card connector as claimed in claim 2, wherein said bottom cover shell comprises two side walls disposed at two opposite lateral sides and defining with said top cover shell an IC card insertion slot for receiving an IC card.

3. The IC card connector as claimed in claim 3, wherein said bottom cover shell comprises a center opening, two terminal holes symmetrically disposed at front and rear sides of said center opening for the positioning of said terminals for enabling said contact portions of said terminals to be respectively suspended in said center opening.

4. The IC card connector as claimed in claim 1, wherein said insulation housing comprises a bottom cover shell, and a top cover shell covered on said bottom cover shell to hold said terminals and said actuating member inside said bottom cover shell.

5. The IC card connector as claimed in claim 4, wherein said terminals each have a soldering portion formed in a second end thereof, respectively said soldering portion extended out front and rear sides of said bottom cover shell for soldering to an external circuit board.

6. The IC card connector as claimed in claim 4, wherein said actuating member is suspended in said center opening of said bottom cover shell, having a middle part pivoted to said bottom cover shell.

7. The IC card connector as claimed in claim 1, wherein said bearing portion and said push portion of said actuating member are respectively formed in two distal ends of said actuating member.

8. The IC card connector as claimed in claim 1, wherein said actuating member further comprises a guide portion extended from said bearing portion in direction toward said push portion and adapted for guiding said IC card toward a top side of said bearing portion.
